(19) United States
(12) Patent Application Publication
(10) Pub. No.: US 2024/0332744 A1
(43) Pub. Date: Oct. 3, 2024

(54) BATTERY MODULE

(71) Applicant: HONDA MOTOR CO., LTD., Tokyo (JP)

(72) Inventors: Takeo FUJII, Saitama (JP); Hidemasa USUI, Saitama (JP); Masanari HIGUCHI, Saitama (JP)

(21) Appl. No.: 18/585,082

(22) Filed: Feb. 23, 2024

(30) Foreign Application Priority Data
Mar. 31, 2023 (CN) 202310336453.0

(51) Int. Cl. H01M 50/489; H01M 10/0525; H01M 50/103; H01M 50/477; H01M 50/483

(52) U.S. Cl. CPC H01M 50/489; H01M 10/0525; H01M 50/103; H01M 50/477; H01M 50/483

(57) ABSTRACT

Provided is a battery module that includes: a battery cell laminate including a plurality of battery cells laminated together; a pair of plate-shaped members that are provided at both ends of the battery cell laminate in a direction of lamination; and a cushion material that is disposed between the plurality of battery cells and/or between the battery cell laminate and the plate-shaped member, the cushion material including a pair of first elastic members that are disposed on both outer sides in the direction of lamination of the battery cell laminate, a second elastic member that is disposed between the pair of first elastic members, and rigid members that are respectively disposed between the first elastic members and the second elastic member, and each of the first elastic members including an exterior body and a fluid that is filled in a space formed between the exterior body and the rigid member.

This application is based on and claims the benefit of priority from Chinese Patent Application No. CN202310336453.0, filed on 31 Mar. 2023, the content of which is incorporated herein by reference.

### BACKGROUND OF THE INVENTION

### Field of the Invention

The present invention pertains to a battery module.

### Related Art

In recent years, research and development pertaining to secondary batteries that contribute to improving energy efficiency has been carried out in order to ensure access to sustainable and advanced energy that is affordable and can be trusted by many people.

Because a battery cell expands and contracts in conjunction with charging and discharging, a battery module is provided with, for example, a pair of end plates that are provided at both ends of a battery cell laminate in the direction of lamination, and a bind bar that retains the battery cell laminate between the pair of end plates.

However, because there is a large change in the volume of an all-solid-state battery cell in conjunction with expansion and contraction at times of charging or discharging, the dimensions of a battery module change, and mounting the battery module into a vehicle becomes difficult.

Japanese Unexamined Patent Application, Publication No. 2020-77500 describes a battery pack in which gap adjustment units are intermittently disposed between all-solid-state battery cells. Here, a gap adjustment unit is disposed between a pair of plates.
Patent Document 1: Japanese Unexamined Patent Application, Publication No. 2020-77500

### SUMMARY OF THE INVENTION

However, there is room for improvement in the energy density of a battery module.

For example, in order to further absorb expansion and contraction by an all-solid-state battery cell at times of charging and discharging, consideration can be given to using a cushion material in which a second elastic member is disposed between a pair of first elastic members.

However, when the cushion material is compressed in conjunction with expansion by the all-solid-state battery cell at a time of charging, there are cases where a difference between the surface pressure of regions where the first elastic member is in contact with the second elastic member as well as the vicinity thereof and the surface pressure of other regions increases, and the uniformity of the surface pressure of the cushion material decreases.

An object of the present invention is to provide a battery module for which it is possible to have improved energy density and uniformity of the surface pressure of a cushion material.

(1) A battery module, including: a battery cell laminate including a plurality of battery cells laminated together; a pair of plate-shaped members that are provided at both ends of the battery cell laminate in a direction of lamination; and a cushion material that is disposed between the plurality of battery cells and/or between the battery cell laminate and the plate-shaped member, the cushion material being provided with a pair of first elastic members that are disposed on both outer sides in the direction of lamination of the battery cell laminate, a second elastic member that is disposed between the pair of first elastic members, and rigid members that are respectively disposed between the first elastic members and the second elastic member, and each of the first elastic members including an exterior body and a fluid that is filled in a space formed between the exterior body and the rigid member.

(2) The battery module according to (1) in which the exterior body has elasticity, and the fluid is a liquid.

(3) The battery module according to (1) or (2), in which the rigid member includes stainless steel.

(4) A battery module, including: a battery cell laminate including a plurality of battery cells laminated together; a pair of plate-shaped members that are provided at both ends of the battery cell laminate in a direction of lamination; and a cushion material that is disposed between the plurality of battery cells and/or between the battery cell laminate and the plate-shaped member, the cushion material including a pair of first elastic members that are disposed on both outer sides in the lamination direction of the battery cell laminate and a second elastic member that is disposed between the pair of first elastic members, and each of the first elastic members including an exterior body and a fluid that is filled inside the exterior body.

(5) The battery module according to (4), in which the exterior body is a metal foil or a laminate film, and the fluid is a liquid.

(6) The battery module according to any one of (1) to (5), in which the second elastic member includes a leaf spring.

(7) The battery module according to any one of (1) to (6), in which each of the battery cells is a solid-state battery cell.

By virtue of the present invention, it is possible to provide a battery module for which it is possible to have improved energy density and uniformity of the surface pressure of a cushion material.

### BRIEF DESCRIPTION OF THE DRAWINGS

FIG. 1 is a cross-sectional view that illustrates an example of a battery module according to the present embodiment.

FIG. 2 is a partially enlarged sectional view of the battery module in FIG. 1.

FIG. 3 is a partially enlarged sectional view of a cushion material in FIG. 2.

FIG. 4 is a cross-sectional view that illustrates a portion of a variation of the cushion material in FIG. 2.

FIG. 5 is a cross-sectional view that illustrates a variation of a rigid member and a first elastic member in FIG. 3.

### DETAILED DESCRIPTION OF THE INVENTION

With reference to the drawings, description is given below regarding embodiments of the present invention.

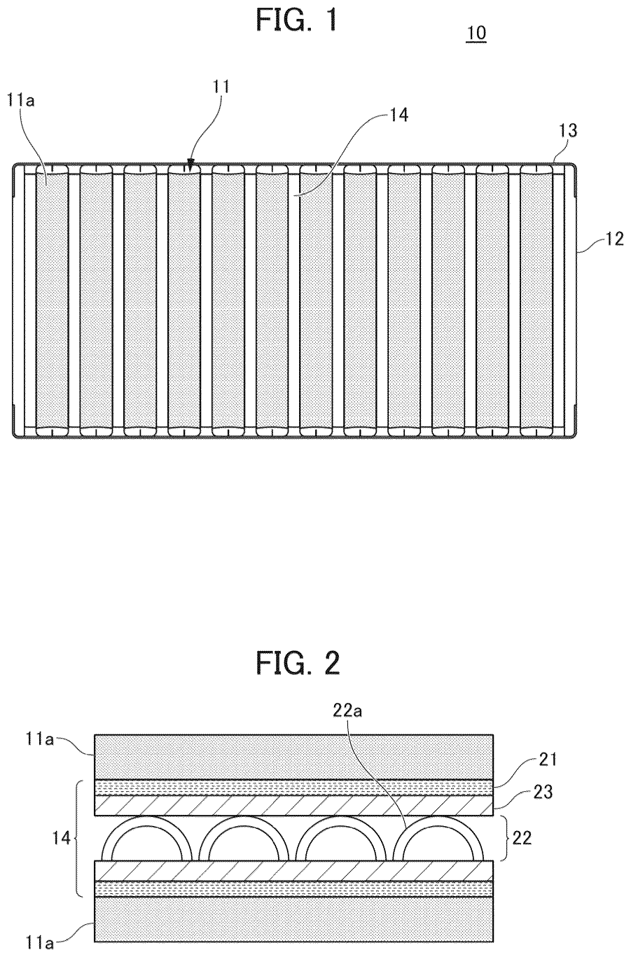

FIG. 1 is a cross-sectional view that illustrates an example of a battery module according to the present embodiment.

A battery module 10 is provided with a battery cell laminate 11 in which a plurality of battery cells 11a are laminated, end plates 12 that serve as a pair of plate-shaped members provided at both ends of the battery cell laminate 11 in the direction of lamination, and bind bars 13 that serve as retaining members for retaining the battery cell laminate 11 between the pair of end plates 12. Here, the bind bars 13 are mounted at two locations: at an upper section and a lower section in the drawing.

In the battery module 10, cushion materials 14 are disposed between the plurality of battery cells 11a and between the battery cell laminate 11 and the end plates 12.

Note that it may be that the cushion materials 14 are respectively disposed between the plurality of battery cells 11a or between the battery cell laminate 11 and the end plate 12.

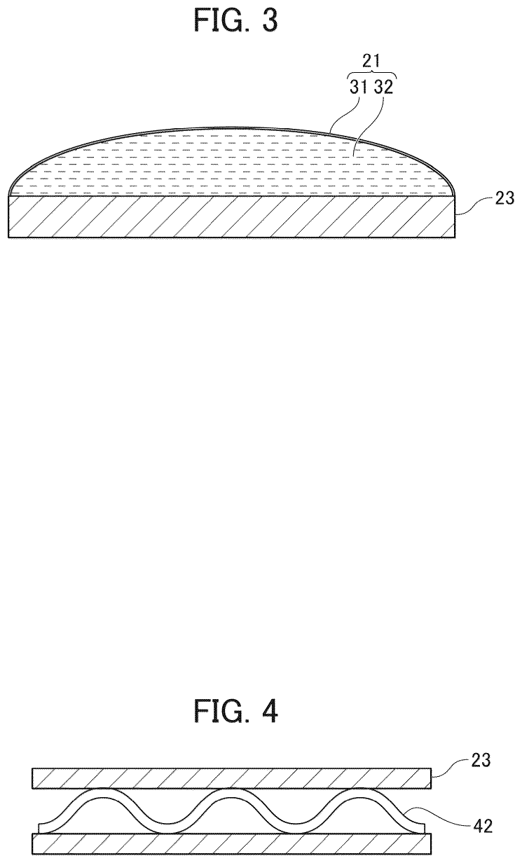

As illustrated in FIG. 2, the cushion material 14 includes a pair of first elastic members 21 that are disposed on both outer sides in the direction of lamination for the battery cell laminate 11, a second elastic member 22 that is disposed between the pair of first elastic members 21, and rigid members 23 that are respectively disposed between the first elastic members 21 and the second elastic member 22. Here, a plurality of leaf springs 22a each having an arc-shaped cross section are disposed in parallel in the second elastic member 22. In addition, as illustrated in FIG. 3, each first elastic member 21 is provided with an exterior body 31, and a fluid 32 that fills a space that is formed between the exterior body 31 and the rigid member 23.

Here, because each rigid member 23 is disposed between a first elastic member 21 and the second elastic member 22, when the cushion material 14 is compressed in conjunction with expansion by the battery cell 11a at a time of charging, a difference between the surface pressure of regions where the first elastic member 21 is in contact with the leaf springs 22a through the rigid member 23 as well as the vicinity thereof and the surface pressure of other regions decreases, and the uniformity of the surface pressure of the cushion material 14 increases. In conjunction with this, uniformity of the temperature of the cushion material 14 in a case where a battery cell 11a has generated heat also increases.

In contrast to this, when foamed polyurethane (an elastic member) is disposed in place of the first elastic member 21 and the rigid member 23—in other words when the second elastic member 22 is disposed between a pair of foamed polyurethanes, there are cases where only the regions where the foamed polyurethane is in contact with the leaf springs 22a as well as the vicinity thereof are compressed when the cushion material is compressed. As a result, the difference between the surface pressure of the regions where the foamed polyurethane is in contact with the leaf springs 22a as well as the vicinity thereof and the surface pressure of other regions increases, and the uniformity of the surface pressure of the cushion material decreases. This tendency is prominent in a case where the thickness of the foamed polyurethane is low, in other words in a case where the battery module has a high energy density.

It is desirable for the exterior body 31 to have elasticity. As a result, it is possible to increase the uniformity of the surface pressure of the cushion material.

The exterior body 31 that has elasticity is not limited in particular, but may be a rubber film, for example. The rubber for forming the rubber film is not limited in particular, but may be silicone rubber (VMQ), ethylene propylene diene rubber (EPDM), fluororubber (FKM), nitrile rubber (NBR), hydrogenated nitrile rubber (HNBR), chloroprene rubber (CR), acrylic rubber (ACM), butyl rubber (IIR), urethane rubber (U), chlorosulfonated polyethylene rubber (CSM), or epichlorohydrin rubber (ECO), for example.

The Young's modulus of the exterior body 31 is not limited in particular, but is greater than or equal to 1 MPa and less than or equal to 100 MPa, for example.

The fluid 32 may be either of a liquid and a gas, but is desirably a liquid. As a result, the uniformity of the surface pressure of the cushion material 14 increases.

The liquid may be mineral hydraulic oil, phosphate ester hydraulic oil, water, or glycol, for example. In addition, the gas may be nitrogen, for example.

The thickness of the first elastic member 21 at SOC 100% is not limited in particular, but is greater than or equal to 0.05 mm and less than or equal to 0.5 mm, for example.

The first elastic member 21 is manufactured by, for example, disposing the exterior body 31 on a surface of the rigid member 23 that is orthogonal to the lamination direction of the battery cell laminate 11, joining the outer circumferential section of the exterior body 31, and subsequently causing the fluid 32 to flow in between the exterior body 31 and the rigid member 23.

The Young's modulus of the rigid member 23 is not limited in particular, but is greater than or equal to 10 GPa and less than or equal to 200 GPa, for example.

A material for forming the rigid member 23 is not limited in particular, but may be a metal such as stainless steel, or fiber-reinforced plastic (FRP), for example.

The Young's modulus of the rigid member 23 is not limited in particular, but is greater than or equal to 10 GPa and less than or equal to 200 GPa, for example. The Poisson's ratio of the rigid member 23 is not limited in particular, but is greater than or equal to 0.2 and less than or equal to 0.4, for example.

The thickness of the rigid member 23 is not limited in particular, but is greater than or equal to 0.05 mm and less than or equal to 0.4 mm, for example.

The Young's modulus of each leaf spring 22a is not limited in particular, but is greater than or equal to 35 GPa and less than or equal to 200 GPa, for example.

Material for forming each leaf spring 22a is not limited in particular, but may be a metal such as stainless steel or carbon steel, a resin such as an epoxy resin, a phenolic resin, or a nylon resin, or a fiber-reinforced plastic (FRP), for example.

The thickness of the second elastic member 22 at SOC 100% is not limited in particular, but is greater than or equal to 0.1 mm and less than or equal to 2.0 mm, for example.

Note that a spring other than the second elastic member 22 may be used as the second elastic member. For example, a corrugated leaf spring 42 (refer to FIG. 4) may be disposed as the second elastic member. As a result, manufacture of the cushion material is facilitated.

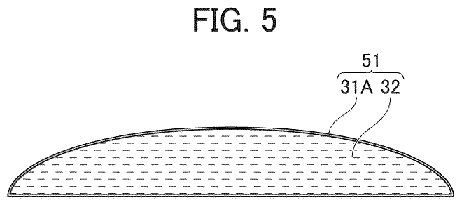

FIG. 5 illustrates a variation for the first elastic member 21 and the rigid member 23.

A first elastic member 51 is provided with an exterior body 31A and a fluid 32 that is filled inside the exterior body 31A. Here, is exterior body 31A serves as both of the rigid member 23 and the exterior body 31 in the cushion material 14.

The exterior body 31A is not particularly limited if it is possible to improve the uniformity of the surface pressure of the cushion material, but may be a metal foil or a laminate film, for example.

A metal for forming the metal foil is not particularly limited, but may be aluminum, for example.

For the laminate film, a metal layer is formed on a surface of a resin layer, for example. The resin may be polyethylene, polyvinyl fluoride, or polyvinylidene chloride, for example, and the metal may be aluminum, for example.

The Young's modulus of the exterior body 31A is not limited in particular, but is greater than or equal to 35 GPa and less than or equal to 200 GPa, for example. The Poisson's ratio of the exterior body 31A is not limited in particular, but is greater than or equal to 0.2 and less than or equal to 0.5, for example.

Each battery cell 11a is not limited in particular, but may be a lithium metal battery cell, or a solid-state battery cell such as an all-solid-state lithium metal battery cell or an all-solid-state lithium-ion battery cell, for example. From among these, a solid-state battery cell is desirable.

Description is given below regarding a case where each battery cell 11a is an all-solid-state lithium metal battery cell.

The all-solid-state lithium metal battery cell results from sequentially laminating a positive electrode current collector, a positive electrode mixture layer, a solid electrolyte layer, a lithium metal layer, and a negative electrode current collector, for example.

The positive electrode current collector is not limited in particular, but may be aluminum foil, for example.

The positive electrode mixture layer includes a positive electrode active material, and may also include a solid electrolyte, an electrically conductive aid, a binder, or the like.

The positive electrode active material is not particularly limited as long as the positive electrode active material can occlude and discharge lithium ions, but may be LiCoO₂, Li(Ni_{5/10}Co_{2/10}Mn_{3/10})O₂, Li(Ni_{6/10}Co_{2/10}Mn_{2/10})O₂, Li(N_{18/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, or sulfur, for example.

A solid electrolyte for forming the solid electrolyte layer is not limited in particular if the solid electrolyte is a material that can conduct lithium ions, but may be an oxide electrolyte or a sulfide electrolyte, for example.

The negative electrode current collector is not limited in particular, but may be copper foil, for example.

Description is given above regarding embodiments of the present invention, but the present invention is not limited to the embodiments described above, and the embodiments described above may be changed, as appropriate, within the scope of the gist of the present invention.

### EXPLANATION OF REFERENCE NUMERALS

10 Battery module
11 Battery cell laminate
11a Battery cell
12 End plate
13 Bind bar
14 Cushion material
21, 51 First elastic member
22 Second elastic member
22a Leaf spring
23 Rigid member
31, 31A Exterior body
32 Fluid
42 Corrugated leaf spring

What is claimed is:

1. A battery module, comprising:
a battery cell laminate including a plurality of battery cells laminated together;
a pair of plate-shaped members that are provided at both ends of the battery cell laminate in a direction of lamination; and
a cushion material that is disposed between the plurality of battery cells and/or between the battery cell laminate and the plate-shaped member,
wherein the cushion material includes a pair of first elastic members that are disposed on both outer sides in the direction of lamination of the battery cell laminate, a second elastic member that is disposed between the pair of first elastic members, and rigid members that are respectively disposed between the first elastic members and the second elastic member, and
each of the first elastic members includes an exterior body and a fluid that is filled in a space formed between the exterior body and the rigid member.

2. The battery module according to claim 1, wherein
the exterior body has elasticity, and
the fluid is a liquid.

3. The battery module according to claim 1, wherein
the rigid member includes stainless steel.

4. A battery module, comprising:
a battery cell laminate including a plurality of battery cells laminated together;
a pair of plate-shaped members that are provided at both ends of the battery cell laminate in a direction of lamination; and
a cushion material that is disposed between the plurality of battery cells and/or between the battery cell laminate and the plate-shaped member,
wherein the cushion material includes a pair of first elastic members that are disposed on both outer sides in the lamination direction of the battery cell laminate, and a second elastic member that is disposed between the pair of first elastic members, and
each of the first elastic members includes an exterior body and a fluid that is filled inside the exterior body.

5. The battery module according to claim 4, wherein
the exterior body is a metal foil or a laminate film, and
The fluid is a liquid.

6. The battery module according to claim 1, wherein
the second elastic member includes a leaf spring.

7. The battery module according to claim 1, wherein
each of the battery cells is a solid-state battery cell.
